(19) United States
(12) Patent Application Publication
(10) Pub. No.: US 2012/0017672 A1
(43) Pub. Date: Jan. 26, 2012

(54) Tire pressure monitoring system and tire pressure sensor thereof

(75) Inventors: Sung-Sun Uh, Gyeonggi-do (KR); Yong-Joon Kim, Gyeonggi-do 420-830 (KR); Young-Man Jang, Gyeonggi-do 420-140 (KR)

(73) Assignee: SEETRON INC., Gyeonggi-do (KR)

(21) Appl. No.: 13/259,467

(22) PCT Filed: Apr. 7, 2009
(86) PCT No.: PCT/KR09/01773

§ 371 Date: Oct. 13, 2011

(30) Foreign Application Priority Data
Apr. 1, 2009 (KR) 10-2009-0028148

(51) Int. Cl. B60C 23/04

(52) U.S. Cl. 73/146.8

(57) ABSTRACT

Provided is a tire pressure sensor (TPS) of a tire pressure monitoring system (TPMS). The TPS includes a detachable and angle-adjustable tire valve coupled to the front side of a tire pressure sensor housing. A holder bracket having a tire valve insertion hole is at the front side, and an insertion head inserted into the valve insertion hole is at an end of the tire valve. Accordingly, the angle of the tire valve is freely controlled, allowing compatible use regardless of the shape or size of wheels of cars and commercial vehicles. Thus, manufacturing costs can be greatly reduced, thereby obtaining superior competitiveness over competitors' products. Furthermore, air leakage through a wheel valve hole can be effectively prevented against high speed rotation and inertia motion caused by the high speed rotation during the driving of a vehicle.

### BACKGROUND OF THE INVENTION

1. Field of the Invention

The present invention relates to a tire pressure monitoring system, and more particularly, to a tire pressure monitoring system and a tire pressure sensor of the system wherein the angle of a tire valve from a tire pressure sensor housing is freely controlled, allowing compatible use regardless of the shape or size of wheels of cars and commercial vehicles.

2. Description of the Related Art

Vehicle manufacturers are required to install a tire air pressure alarming device on a vehicle under FMVSS 138 of NHTSA (National Highway Traffic Safety Administration).

A tire air pressure alarming device installed on a vehicle may also be called a tire pressure monitoring system (TPMS) that includes a tire pressure sensor (TPS) installed on each tire of a vehicle and having its own ID. A transmitter constituting a wireless apparatus transmits radio waves to the TPS to read the ID of the TPS, and a value corresponding to the ID is transmitted to an electronic control unit (ECU) of the vehicle. Accordingly, a defective tire can be detected by the driver, and be properly managed.

Vehicles to be exported to the US are required to have a TPMS by NHTSA's FMVSS 138, and Europe and Korea plan to enforce a rule related with a TPMS in 2012. Application of a TPMS is gradually increased, and will be mandatory for all vehicles. This is because a vehicle driven at high speed with air pressure of a tire being decreased by 25% or greater may cause an accident. That is, standing wave of a tire at high speed may separate the inside and outside of the tire from each other, and thus, the tire may go flat. In the US, TPMSs are currently applied to cars and commercial vehicles weighing 4.5 tons or less, and will be applied to heavy trucks.

Tire wheels used for cars and commercial vehicles have various sizes, shapes, and structures. Tire valves for cars may have a diameter of 6 mm or 11.5 mm according a size of a wheel valve hole. A stem length of tire valves may be varied according to a wheel shape. Tire wheels for commercial vehicles may be classified into 17.5-inch wheels, 19.5-inch wheels, and 22.5-inch wheels according to their sizes, or be classified into steel wheels and aluminum wheels according to their materials, or be classified into casting wheels and forging wheels according to their manufacturing processes, and thus, are various in type, shape, size, and structure.

Thus, TPSs are also various according to valve hole sizes and wheel sizes, or wheel designs since a tire pressure sensor housing is integrally formed with a tire valve to fix the angle of the tire valve.

In other words, since a tire pressure sensor housing is integrally formed with a tire valve to fix the angle of the tire valve, TPSs should be manufactured differently according to valve hole sizes and wheel sizes, or wheel designs, thereby increasing manufacturing costs thereof.

### SUMMARY OF THE INVENTION

Accordingly, the present invention is directed to a tire pressure monitoring system and a tire pressure sensor of the system, which substantially obviates one or more problems due to limitations and disadvantages of the related art.

An object of the present invention is to provide a tire pressure monitoring system and a tire pressure sensor of the system, which includes a detachable and angle-adjustable tire valve coupled to the front side of a tire pressure sensor housing, thereby freely controlling the angle of the tire valve and allowing compatible use regardless of the shape or size of wheels of cars and commercial vehicles.

Another object of the present invention is to provide a tire pressure monitoring system and a tire pressure sensor of the system, which can effectively prevent air leakage through a wheel valve hole against high speed rotation and inertia motion caused by the high speed rotation during the driving of a vehicle.

Another object of the present invention is to provide a tire pressure monitoring system and a tire pressure sensor of the system, in which the tire pressure sensor is installed on a wheel as low as possible to prevent damage to a tire while being installed/uninstalled.

According to an aspect of the present invention, there is provided a tire pressure sensor including: a tire pressure sensor housing installed on a side portion of a wheel to sense air pressure of a tire; an angle-adjustable tire valve coupled to the tire pressure sensor housing, having an end exposed out of the wheel through a wheel valve hole, and including a male screw part on a middle outer surface; a rubber grommet disposed on an inner surface corresponding to the wheel valve hole to prevent air from leaking out of the tire; a washer fitted on the tire valve to support the rubber grommet; and a fastening nut coupled to the male screw part of the tire valve.

A surface of the tire pressure sensor housing may be provided with a holder bracket including a valve insertion hole, and an end of the tire valve may be provided with an insertion head inserted in the valve insertion hole.

According to another aspect of the present invention, there is provided a tire pressure sensor including: a tire pressure sensor housing installed on a side portion of a wheel to sense air pressure of a tire; and a detachable and angle-adjustable tire valve coupled to a surface of the tire pressure sensor housing, wherein the surface of the tire pressure sensor housing is provided with a holder bracket including a valve insertion hole, and an end of the tire valve is provided with an insertion head inserted in the valve insertion hole.

A side lower surface of the tire pressure sensor housing may be provided with a supporting protrusion.

An angle of the tire valve may vary in a range from about 24° to about 41°.

An angle of the tire valve may vary in a range from about 28° to about 88°.

The holder bracket of the tire pressure sensor housing may be formed through die casting, and then, be integrated with a body through insert injection molding.

The holder bracket receiving the insertion head of the tire valve may have a certain arc, and a center of the arc may be disposed in a center of the tire pressure sensor housing.

The arc may have a radius of about 10 mm when being applied to a car, and the arc may have a radius of about 7.2 mm when being applied to a commercial vehicle.

When the insertion head of the tire valve is inserted in the valve insertion hole of the holder bracket, a bottom surface of the holder bracket may be provided with an arc-shaped insertion part, and an arc-shaped round part may be provided to the insertion head to correspond to the insertion part such that the tire valve is inserted in the tire pressure sensor housing in a perpendicular direction to the tire pressure sensor housing, and be rotated through about 90°, and an upper end of the holder bracket may be provided with a catching rack to prevent an unintentional removal of the tire valve from the valve insertion hole of the holder bracket.

The catching rack of the holder bracket may be disposed at a lower level than that of the tire pressure sensor housing.

Both end surfaces of the insertion head may closely contact both side inner walls of the holder bracket to prevent a rotation of the tire valve when rotating the fastening nut.

The insertion head of the tire valve may be provided with a slope to efficiently install the tire valve, and the insertion head may be in line contact with the holder bracket of the tire pressure sensor housing.

A catching recess corresponding to a catching rack may be adjacent to the slope to couple the holder bracket to the tire valve within a height of the tire pressure sensor housing.

Another object of the present invention is to provide a tire pressure monitoring system including: a tire pressure sensor housing installed on a side portion of a wheel to sense air pressure of a tire; an angle-adjustable tire valve coupled to a surface of the tire pressure sensor housing, having an end exposed out of the wheel through a wheel valve hole, and including a male screw part on a middle outer surface; a rubber grommet disposed on an inner surface corresponding to the wheel valve hole to prevent air from leaking out of the tire; a washer fitted on the tire valve to support the rubber grommet; a fastening nut coupled to the male screw part of the tire valve; and a receiver receiving a wireless signal denoting an air pressure state of the tire, from the tire pressure sensor housing.

The tire pressure monitoring system may further include a display that receives the wireless signal from the receiver to notify a driver whether the air pressure state is normal.

The surface of the tire pressure sensor housing may be provided with a holder bracket including a valve insertion hole, and an end of the tire valve may be provided with an insertion head inserted in the valve insertion hole.

### BRIEF DESCRIPTION OF THE DRAWINGS

FIG. 1 is perspective view illustrating a tire pressure monitoring system (TPMS) according to an embodiment of the present invention.

FIG. 2 is a schematic view illustrating an installation state of a display of FIG. 1.

FIG. 3 is a cross-sectional view illustrating an installation state of a tire pressure sensor of the tire pressure monitoring system of FIG. 1.

FIG. 4 is a perspective view illustrating a tire pressure sensor for a car according to an embodiment of the present invention.

FIG. 5 is an exploded perspective view illustrating the tire pressure sensor of FIG. 4.

FIG. 6 is a plan view illustrating the tire pressure sensor of FIG. 4.

FIG. 7 is a side view illustrating the tire pressure sensor of FIG. 4.

FIG. 8 is a side view illustrating a tire valve of FIG. 4.

FIG. 9 is a plan view illustrating the tire valve of FIG. 8.

FIG. 10 is a rear view illustrating the tire valve of FIG. 8.

FIGS. 11A and 11B are cross-sectional views illustrating installation states of the tire pressure sensor of FIG. 4 according to shapes of a wheel.

FIG. 12 is a perspective view illustrating a tire pressure sensor for a commercial vehicle according to another embodiment of the present invention.

FIG. 13 is a perspective view illustrating a tire pressure sensor housing of FIG. 12.

FIG. 14 is a plan view illustrating the tire pressure sensor of FIG. 12.

FIG. 15 is a side view illustrating the tire pressure sensor of FIG. 12.

FIG. 16 is a side view illustrating a tire valve of FIG. 15.

FIG. 17 is a plan view illustrating the tire valve of FIG. 15.

FIG. 18 is a rear view illustrating the tire valve of FIG. 15.

FIGS. 19A and 19B are cross-sectional views illustrating installation states of the tire pressure sensor of FIG. 12 according to shapes of a wheel.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

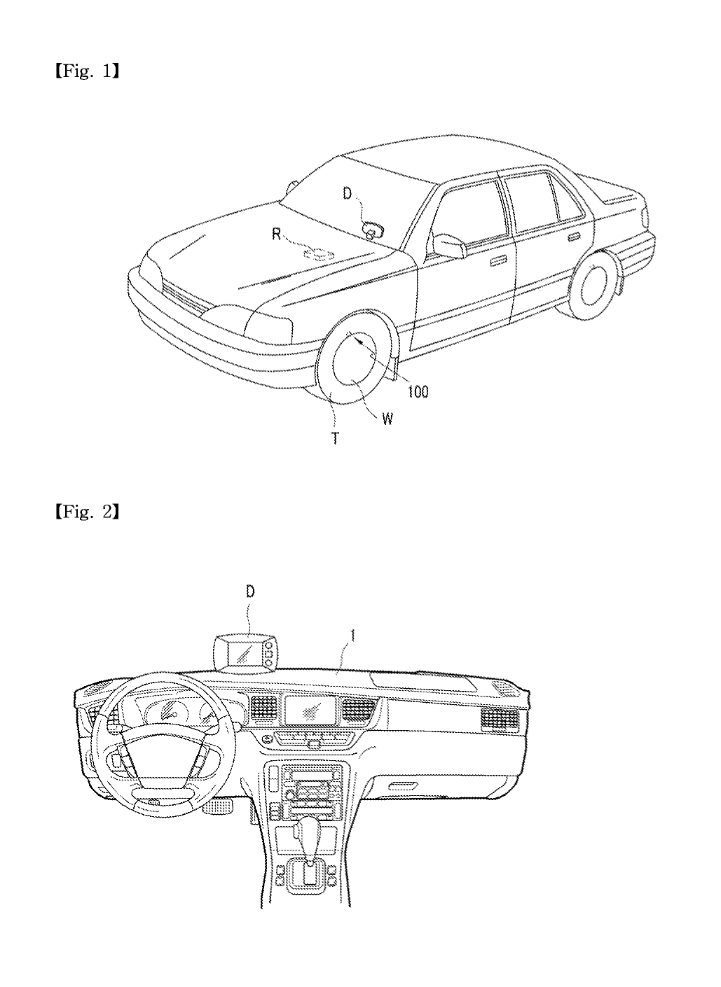

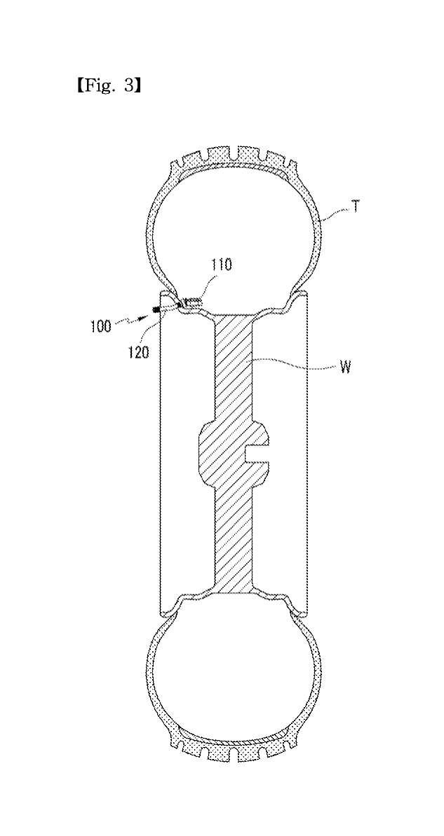

FIG. 1 is perspective view illustrating a tire pressure monitoring system (TPMS) according to an embodiment of the present invention. FIG. 2 is a schematic view illustrating an installation state of a display of FIG. 1. FIG. 3 is a cross-sectional view illustrating an installation state of a tire pressure sensor (TPS) of the tire pressure monitoring system of FIG. 1.

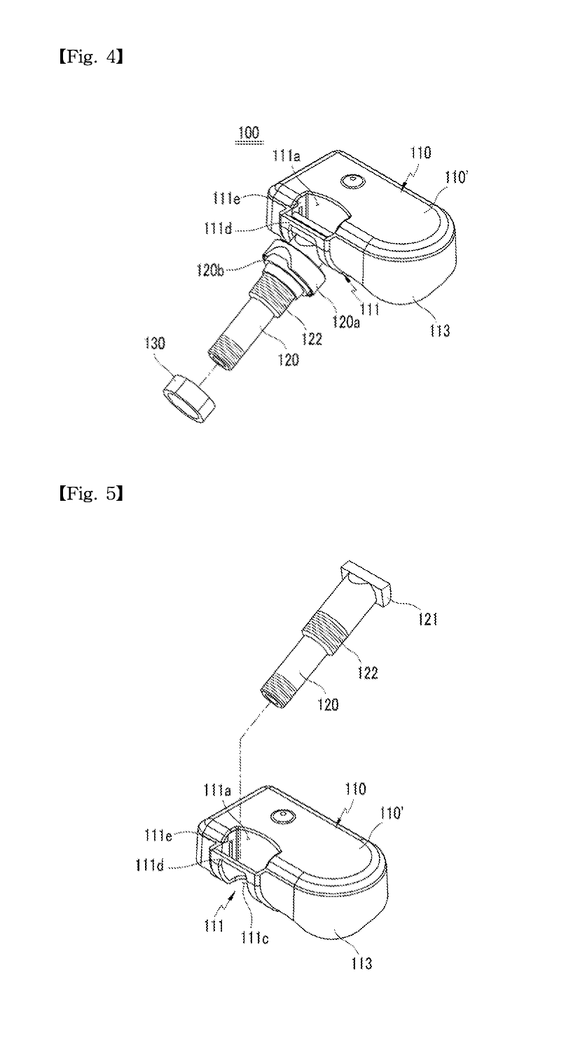

Referring to FIGS. 1 to 3, a tire pressure monitoring system according to the current embodiment includes: a tire pressure sensor housing 110 installed on a side portion of a wheel W to sense air pressure of a tire T; an angle-adjustable tire valve 120 coupled to the tire pressure sensor housing 110, having an end exposed out of the wheel W through a wheel valve hole H (refer to FIG. 7), and including a male screw part 122 (refer to FIG. 4) on a middle outer surface; a fastening nut 130 (refer to FIG. 7) coupled to the male screw part 122; a rubber grommet 120b disposed on an inner surface corresponding to the wheel valve hole H to prevent air from leaking out of the tire T; a washer 120a fitted on the tire valve 120 to support the rubber grommet 120b; a receiver R receiving a wireless signal denoting an air pressure state of the tire T, from the tire pressure sensor housing 110; and a display D receiving the wireless signal from the receiver R to notify a driver whether the air pressure state is normal. The receiver R may be disposed in a vehicle or the display D.

The display D uses a screen to notify the driver whether an air pressure state of the tire T is normal, and may be fixed to the upper portion of a dash panel 1 by a typical fixing member.

The tire pressure monitoring system will now be described in more detail.

A tire pressure sensor 100 is installed on each wheel W of a car or a commercial vehicle. When being applied to a car, the tire pressure sensor 100 has one of red, yellow, green, and blue color codes, and is installed in a position designated according to a corresponding one of the color codes.

The color codes are sequentially positioned in the color order of a rainbow clockwise from the driver's seat.

The tire pressure sensor 100 includes the tire pressure sensor housing 110 installed on a side surface of the wheel W to sense air pressure of the tire T, and the detachable and angle-adjustable tire valve 120 coupled to front surface of the tire pressure sensor housing 110.

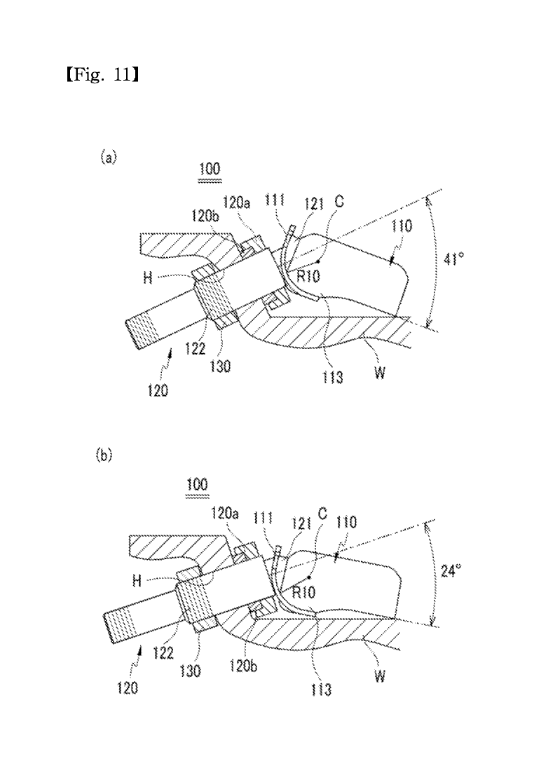

The fastening nut 130 is coupled to the male screw part 122 of the tire valve 120 to fix the tire pressure sensor 100 to the wheel W. The rubber grommet 120b is disposed on the inner surface corresponding to the wheel valve hole H to prevent air leakage from the tire T, and the washer 120a is fitted on the tire valve 120 to support the rubber grommet 120b (refer to FIGS. 11A and 11B).

The receiver R receives, from the tire pressure sensor 100, a signal denoting whether a sensor valve ID and an air pressure state of the tire T are normal, and transmits the signal to the display D. The receiver R may be disposed in a vehicle or the display D.

The display D is disposed on the upper portion of the dash panel 1, and is connected to an inner power source (not shown) of the vehicle, and a power source (not shown) for a cigar jack, to notify the driver whether an air pressure state of the tire T is normal.

The tire pressure sensor 100 will now be described in more detail.

In the current embodiment, the tire pressure sensor 100 is used for a car, and a tire pressure sensor 200 is used for a commercial vehicle. First, the tire pressure sensor 100 will now be described.

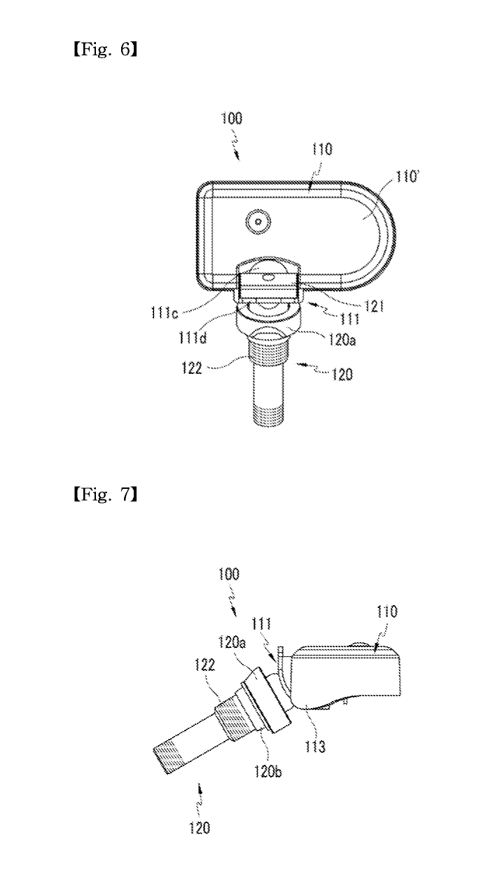

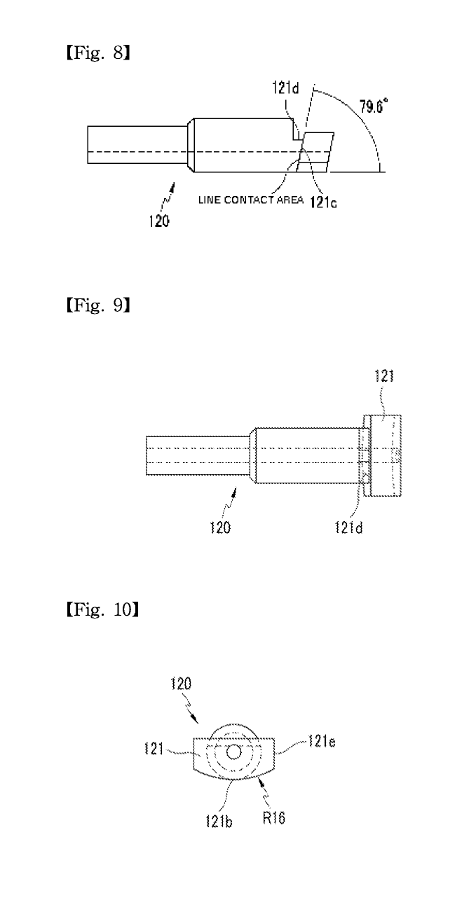

FIG. 4 is a perspective view illustrating a tire pressure sensor for a car according to an embodiment of the present invention. FIG. 5 is an exploded perspective view illustrating the tire pressure sensor of FIG. 4. FIG. 6 is a plan view illustrating the tire pressure sensor of FIG. 4. FIG. 7 is a side view illustrating the tire pressure sensor of FIG. 4. FIG. 8 is a side view illustrating a tire valve of FIG. 4. FIG. 9 is a plan view illustrating the tire valve of FIG. 8. FIG. 10 is a rear view illustrating the tire valve of FIG. 8. FIGS. 11A and 11B are cross-sectional views illustrating installation states of the tire pressure sensor of FIG. 4 according to shapes of a wheel.

Referring to FIGS. 4 to 11B, the tire pressure sensor 100 according to the current embodiment is installed on the wheel W, and is coupled to the front surface of the tire pressure sensor housing 110 such that the tire valve 120 is detachable and angle-adjustable.

The front surface of the tire pressure sensor housing 110 is provided with a holder bracket 111 including a tire valve insertion hole 111a.

The holder bracket 111 is formed of an aluminum alloy through die casting, and then, is integrated with a body 110′ through insert injection molding.

An end of the tire valve 120 is provided with an insertion head 121 inserted in the tire valve insertion hole 111a.

The washer 120a formed of a metal, and the rubber grommet (rubber seal ring) 120b are fitted on a side portion of the tire valve 120, and the fastening nut 130 is coupled to the other side portion of the tire valve 120. When the fastening nut 130 is screwed to the male screw part 122 of the tire valve 120, the rubber grommet 120b tightly closes the wheel valve hole H to prevent air leakage, and the tire pressure sensor 100 closely contacts the wheel W at a smallest angle, thereby effectively preventing damage to the tire pressure sensor 100 while the tire T is installed/uninstalled.

A side lower surface of the tire pressure sensor housing 110 is provided with a supporting protrusion 113. When the fastening nut 130 is coupled to the tire valve 120, the fastening nut 130 is rotated. At this point, the supporting protrusion 113 supports the tire pressure sensor housing 110.

When the insertion head 121 of the tire valve 120 is inserted in the tire valve insertion hole 111a of the holder bracket 111, the bottom surface of the holder bracket 111 is provided with an arc-shaped insertion part 111c, and a round part 121b having an arc shape is provided to the insertion head 121 to correspond to the insertion part 111c. Accordingly, the tire valve 120 can be inserted in the tire pressure sensor housing 110 in a perpendicular direction to the tire pressure sensor housing 110, and be rotated through about 90°. The round part 121b has a radius of about 16 mm (refer to FIGS. 5 and 10). Referring to FIG. 5, the upper end of the holder bracket 111 is provided with a catching rack 111d to prevent an unintentional removal of the tire valve 120 from the tire valve insertion hole 111a of the holder bracket 111.

The insertion head 121 of the tire valve 120 is provided with a slope 121c to efficiently install the tire valve 120. The slope 121c may have an angle of about 79.6°. Referring to FIG. 8, the insertion head 121 of the tire valve 120 is in line contact with the holder bracket 111 of the tire pressure sensor housing 110.

A catching recess 121d corresponding to the catching rack 111d is adjacent to the slope 121c to couple the holder bracket 111 to the tire valve 120 within the height of the tire pressure sensor housing 110. Thus, even when the catching rack 111d of the holder bracket 111 is at a lower level than that of the tire pressure sensor housing 110, the catching rack 111d does not interfere with a rotation of the tire valve 120 as illustrated in FIGS. 7 and 8.

Referring to FIGS. 4 and 10, both end surfaces 121e of the insertion head 121 closely contact both side inner walls 111e of the holder bracket 111 to prevent a rotation of the tire valve 120 when rotating the fastening nut 130.

Since an angle of the tire valve 120, which is used for a car, may vary in a range from about 24° of FIG. 11B to about 41° of FIG. 11A, the tire pressure sensor 100 can be applied to any car, regardless of its wheel shape and size.

The holder bracket 111 receiving the insertion head 121 of the tire valve 120 has a certain arc R. A center C of the arc R is disposed in a center of the tire pressure sensor housing 110. When being applied to a car, the arc R may have a radius of about 10 mm as illustrated in FIGS. 11A and 11B.

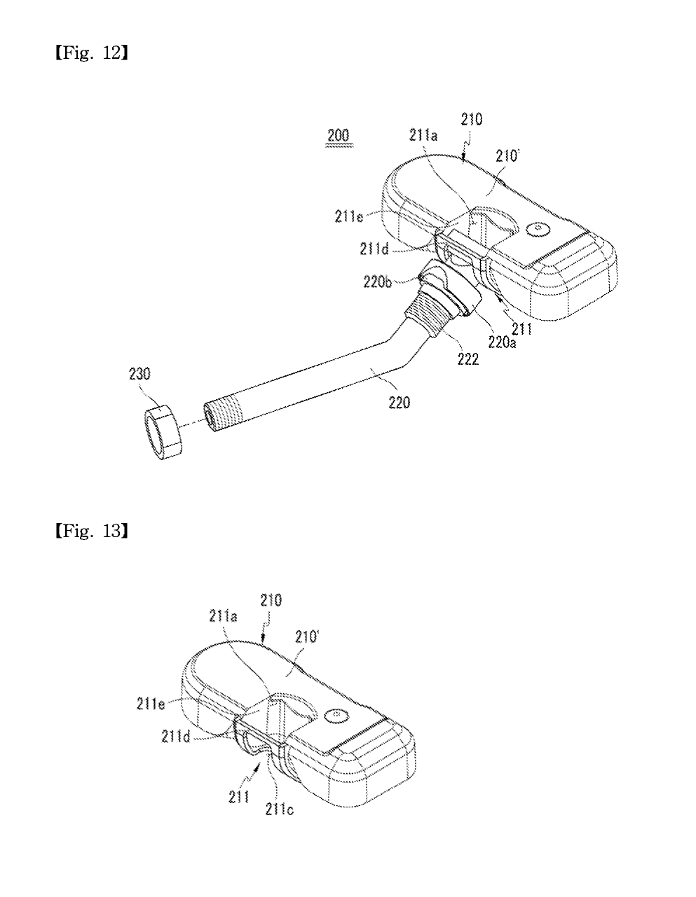

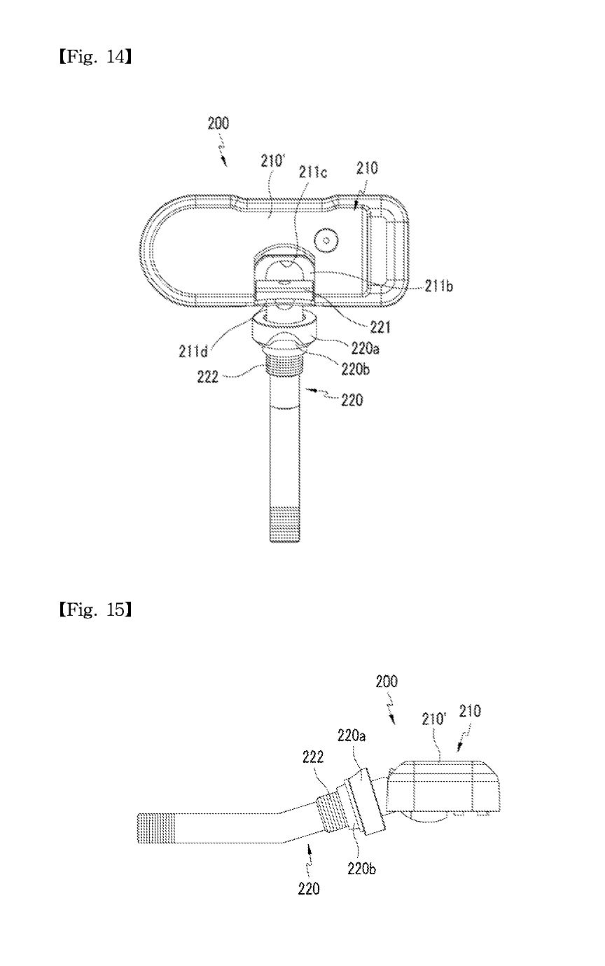

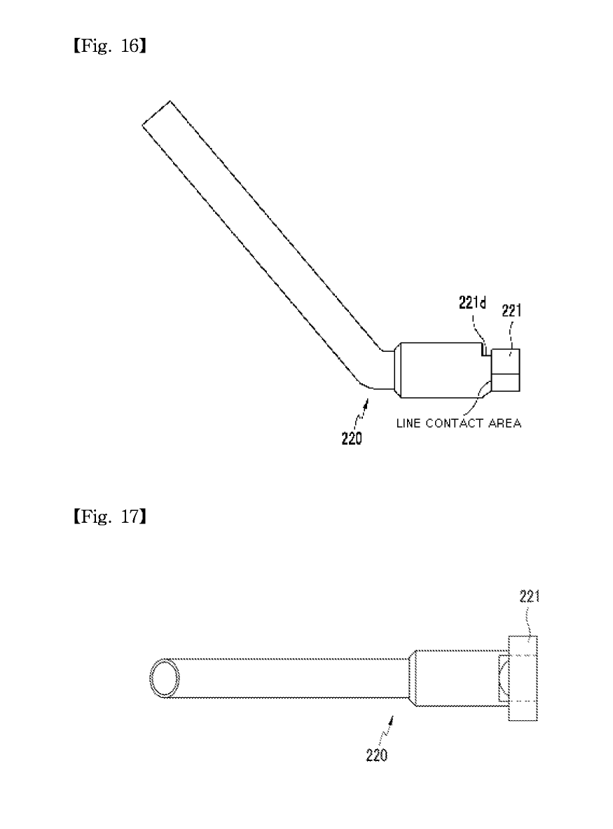

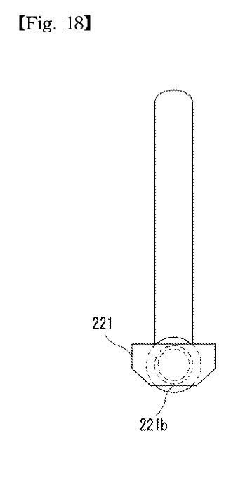

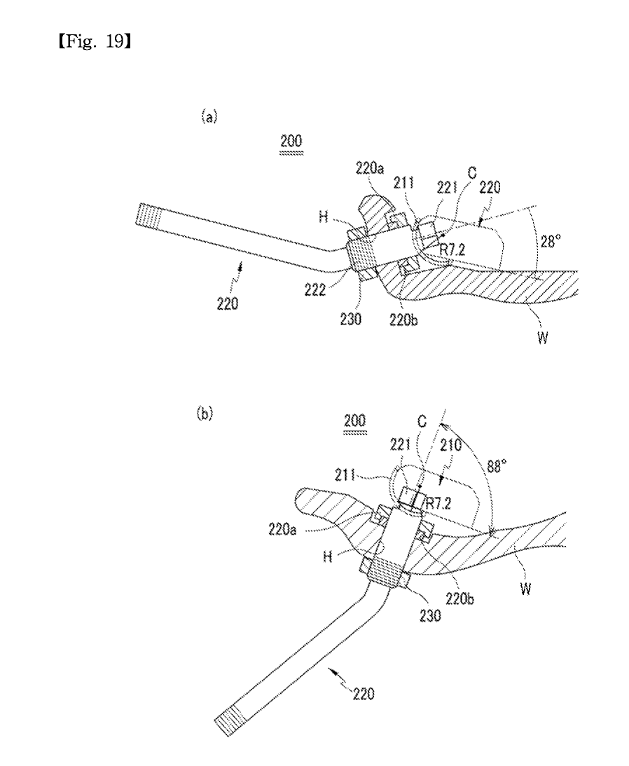

FIG. 12 is a perspective view illustrating a tire pressure sensor for a commercial vehicle according to another embodiment of the present invention. FIG. 13 is a perspective view illustrating a tire pressure sensor housing of FIG. 12. FIG. 14 is a plan view illustrating the tire pressure sensor of FIG. 12. FIG. 15 is a side view illustrating the tire pressure sensor of FIG. 12. FIG. 16 is a side view illustrating a tire valve of FIG. 15. FIG. 17 is a plan view illustrating the tire valve of FIG. 15. FIG. 18 is a rear view illustrating the tire valve of FIG. 15. FIGS. 19A and 19B are cross-sectional views illustrating installation states of the tire pressure sensor of FIG. 12 according to shapes of a wheel.

Referring to FIGS. 12 to 19B, the tire pressure sensor 200 according to the current embodiment is installed on a wheel W that is used for a commercial vehicle, and is coupled to the front surface of a tire pressure sensor housing 210 such that a tire valve 222 is detachable and angle-adjustable.

The front surface of the tire pressure sensor housing 210 is provided with a holder bracket 211 including a tire valve insertion hole 211a.

The holder bracket 211 is formed of an aluminum alloy through die casting, and then, is integrally formed with a body 210′ through insert injection molding, thereby completing the tire pressure sensor housing 210.

An end of the tire valve 220 is provided with an insertion head 221 inserted in the tire valve insertion hole 211a.

A washer 220a formed of a metal, and a rubber grommet (rubber seal ring) 220b are fitted on a side portion of the tire valve 220, and a fastening nut 230 is coupled to the other side portion of the tire valve 220. When the fastening nut 230 is screwed to a male screw part 222 of the tire valve 220, the rubber grommet 220b tightly closes a wheel valve hole H to prevent air leakage, and the tire pressure sensor 200 closely contacts the wheel W at a smallest angle, thereby effectively preventing damage to the tire pressure sensor 200 while a tire T is installed/uninstalled.

Referring to FIGS. 13 and 18, when the insertion head 221 of the tire valve 220 is inserted in the tire valve insertion hole 211a of the holder bracket 211, the bottom surface of the holder bracket 210 is provided with an arc-shaped insertion part 211c, and a bottom part 221b is provided to the insertion head 221 to correspond to the insertion part 211c. Accordingly, the tire valve 220 can be inserted in the tire pressure sensor housing 210 in a perpendicular direction to the tire pressure sensor housing 211, and be rotated through about 90°.

Referring to FIG. 16, the insertion head 221 of the tire valve 220 is in line contact with the holder bracket 210 of the tire pressure sensor housing 210.

Referring to FIG. 13, the upper end of the holder bracket 211 is provided with a catching rack 211d to prevent an unintentional removal of the tire valve 220 from the tire valve insertion hole 211a of the holder bracket 211.

A catching recess 221d is provided to the tire valve 220 to couple the holder bracket 211 to the tire valve 220 within the height of the tire pressure sensor housing 210. Thus, even when the catching rack 211d of the holder bracket 211 is at a lower level than that of the tire pressure sensor housing 211, the catching rack 211d does not interfere with a rotation of the tire valve 220 as illustrated in FIGS. 15 and 16.

Referring to FIGS. 12 and 17, both end surfaces 221e of the insertion head 221 closely contact both side inner walls 211e of the holder bracket 211 to prevent a rotation of the tire valve 220 when rotating the fastening nut 230.

Since an angle of the tire valve 220, which is used for a commercial vehicle, may vary in a range from about 28° of FIG. 19A to about 88° of FIG. 19B, the tire pressure sensor 200 can be applied to any commercial vehicle, regardless of its wheel shape and size.

The holder bracket 211 receiving the insertion head 221 of the tire valve 220 has a certain arc R. A center C of the arc R is disposed in a center of the tire pressure sensor housing 210. When being applied to a commercial vehicle, the arc R may have a radius of about 7.2 mm.

Installation of a tire pressure sensor of a tire pressure monitoring system configured as described above will now be described. For convenience in description and clarity, installation of a tire pressure sensor only for a car will now be described.

Although not shown, a tire T is removed from a car, then, air is removed from the tire T, and then, a tire bead is removed from a wheel W with a tire changer shovel.

The bead of the tire T placed on a tire changer is pressed to remove a typical tire pressure sensor and install the tire pressure sensor 100 on the wheel W. At this point, the tire valve 120 is inserted in the wheel valve hole H, and the fastening nut 130 is coupled to the male screw part 122 of the tire valve 120. The fastening nut 130 is tightened with a torque ranging from about 4.0 Nm to about 12.0 Nm using a torque ranch (not shown). At this point, the fastening nut 130 is tightened as slowly as possible to reduce resistance from the washer 120a and the rubber grommet 120b. When the fastening nut 130 is coupled to the tire valve 120, the tire pressure sensor housing 110 is tightly fixed to a bottom surface of the wheel W without a separate process, and an installation angle of the tire valve 120 is set without a separate process. At this point, the supporting protrusion 113 supports and fixes the tire pressure sensor housing 110 in position. Then, a tire positioning color code corresponding to a color code of the tire pressure sensor 100 is attached to an outer portion of the wheel W to be easily perceived from the outside.

As described above, since the tire valve 120 installed on the front surface of the tire pressure sensor housing 110 is detachable and angle-adjustable, the tire pressure sensor 100 is positioned just by screwing the fastening nut 130 to the male screw part 122 of the tire valve 120.

In addition, since only the tire valve 120 can be separated, maintenance thereof is convenient. In addition, since the tire valve 120 installed on the front surface of the tire pressure sensor housing 110 is detachable and angle-adjustable, the angle of the tire valve 120 is freely controlled, allowing compatible use regardless of the shape or size of wheels of cars and commercial vehicles, thereby reducing manufacturing costs. In addition, when the fastening nut 130 is coupled to the tire valve 120, the tire pressure sensor 100 closely contacts the wheel W, and air leakage through the wheel valve hole H can be effectively prevented against high speed rotation and inertia motion caused by the high speed rotation during the driving of a vehicle.

In addition, the tire pressure sensor 100 is installed on the wheel W as low as possible to prevent damage to the tire T while being installed/uninstalled

It will be apparent to those skilled in the art that various modifications and variations can be made in the present invention. Thus, it is intended that the present invention covers the modifications and variations of this invention provided they come within the scope of the appended claims and their equivalents.

1. A tire pressure sensor comprising:
a tire pressure sensor housing installed on a side portion of a wheel to sense air pressure of a tire;
an angle-adjustable tire valve coupled to the tire pressure sensor housing, having an end exposed out of the wheel through a wheel valve hole, and including a male screw part on a middle outer surface;
a rubber grommet disposed on an inner surface corresponding to the wheel valve hole to prevent air from leaking out of the tire;
a washer fitted on the tire valve to support the rubber grommet; and
a fastening nut coupled to the male screw part of the tire valve.

2. The tire pressure sensor of claim 1, wherein a surface of the tire pressure sensor housing is provided with a holder bracket including a valve insertion hole, and
an end of the tire valve is provided with an insertion head inserted in the valve insertion hole.

3. A tire pressure sensor comprising:
a tire pressure sensor housing installed on a side portion of a wheel to sense air pressure of a tire; and
a detachable and angle-adjustable tire valve coupled to a surface of the tire pressure sensor housing,
wherein the surface of the tire pressure sensor housing is provided with a holder bracket including a valve insertion hole, and
an end of the tire valve is provided with an insertion head inserted in the valve insertion hole.

4. The tire pressure sensor of claim 3, wherein a side lower surface of the tire pressure sensor housing is provided with a supporting protrusion.

5. The tire pressure sensor of claim 3, wherein an angle of the tire valve varies in a range from about 24° to about 41°.

6. The tire pressure sensor of claim 3, wherein an angle of the tire valve varies in a range from about 28° to about 88°.

7. The tire pressure sensor of claim 3, wherein the holder bracket of the tire pressure sensor housing is formed through die casting, and then, is integrated with a body through insert injection molding.

8. The tire pressure sensor of claim 3, wherein the holder bracket receiving the insertion head of the tire valve has a certain arc, and
a center of the arc is disposed in a center of the tire pressure sensor housing.

9. The tire pressure sensor of claim 8, wherein the arc has a radius of about 10 mm when being applied to a car, and
the arc has a radius of about 7.2 mm when being applied to a commercial vehicle.

10. The tire pressure sensor of claim 3, wherein, when the insertion head of the tire valve is inserted in the valve insertion hole of the holder bracket, a bottom surface of the holder bracket is provided with an arc-shaped insertion part, and an arc-shaped round part is provided to the insertion head to correspond to the insertion part such that the tire valve is inserted in the tire pressure sensor housing in a perpendicular direction to the tire pressure sensor housing, and be rotated through about 90°, and
an upper end of the holder bracket is provided with a catching rack to prevent an unintentional removal of the tire valve from the valve insertion hole of the holder bracket.

11. The tire pressure sensor of claim 10, wherein the catching rack of the holder bracket is disposed at a lower level than that of the tire pressure sensor housing.

12. The tire pressure sensor of claim 4, wherein both end surfaces of the insertion head closely contact both side inner walls of the holder bracket to prevent a rotation of the tire valve when rotating the fastening nut.

13. The tire pressure sensor of claim 3, wherein the insertion head of the tire valve is provided with a slope to efficiently install the tire valve, and
the insertion head is in line contact with the holder bracket of the tire pressure sensor housing.

14. The tire pressure sensor of claim 13, wherein a catching recess corresponding to a catching rack is adjacent to the slope to couple the holder bracket to the tire valve within a height of the tire pressure sensor housing.

15. A tire pressure monitoring system comprising:
a tire pressure sensor housing installed on a side portion of a wheel to sense air pressure of a tire;
an angle-adjustable tire valve coupled to a surface of the tire pressure sensor housing, having an end exposed out of the wheel through a wheel valve hole, and including a male screw part on a middle outer surface;
a rubber grommet disposed on an inner surface corresponding to the wheel valve hole to prevent air from leaking out of the tire;
a washer fitted on the tire valve to support the rubber grommet;
a fastening nut coupled to the male screw part of the tire valve; and
a receiver receiving a wireless signal denoting an air pressure state of the tire, from the tire pressure sensor housing.

16. The tire pressure monitoring system of claim 15, further comprising a display that receives the wireless signal from the receiver to notify a driver whether the air pressure state is normal.

17. The tire pressure monitoring system of claim 15, wherein the surface of the tire pressure sensor housing is provided with a holder bracket including a valve insertion hole, and
an end of the tire valve is provided with an insertion head inserted in the valve insertion hole.
